(19) United States
(12) Patent Application Publication
(10) Pub. No.: US 2014/0227405 A1
(43) Pub. Date: Aug. 14, 2014

(54) PROCESS FOR THE PASTEURIZATION OF SAP AND PRODUCTS THEREOF

(71) Applicant: FEDERATION DES PRODUCTEURS ACERICOLES DU QUEBEC, Longueuil (CA)

(72) Inventors: Geneviève Béland, Saint-Hyacinthe (CA); Julie Barbeau, Boucherville (CA)

(73) Assignee: FEDERATION DES PRODUCTEURS ACERICOLES DU QUEBEC, Longueuil (CA)

(21) Appl. No.: 13/955,903

(22) Filed: Jul. 31, 2013

Related U.S. Application Data
(60) Provisional application No. 61/762,695, filed on Feb. 8, 2013.

(51) Int. Cl. A23L 1/09

(52) U.S. Cl. CPC A23L 1/09
USPC 426/240; 426/490; 426/521; 426/248; 426/244; 426/320

(57) ABSTRACT

The present document describes a process for the sterilization and/or pasteurization of sap without denaturing polyphenols and other ingredients present therein, and a sap product prepared from the processes.

### CROSS-REFERENCE TO RELATED APPLICATIONS

This application claims priority under 35 USC §119(e) of U.S. provisional patent application 61/762,695 filed on Feb. 8, 2013, the specification of which is hereby incorporated by reference.

### BACKGROUND

(a) Field

The subject matter disclosed generally relates to a process for the sterilization and/or pasteurization of sap or sap concentrate without denaturing the proteins and other ingredients present therein, and products obtained from such product.

(b) Related Prior Art

To produce high quality maple syrup every effort must be made to maintain high quality sap that is relatively free of microorganisms from the tap hole to the evaporator.

Various species of bacteria, yeast, and mold may be found in maple sap or sap concentrate. Sap is an ideal growth medium for microorganisms because it contains sugars (largely sucrose), minerals, and amino acids suitable for microbial growth and reproduction.

Growing microbial populations have three effects on sap. Firstly, enzymes secreted by microorganisms break down sucrose into glucose and fructose, which causes a darkening in syrup color and a caramel taste; secondly, microorganisms can cause off-flavor and thirdly, increase maple syrup viscosity. These effects are intensified as the temperature warms and microbial growth increases significantly.

There are a variety of methods to control or reduce microbial activity in maple sap or sap concentrate. They include sanitary tapping, keeping sap cool in the sugar bush and storage tanks, boiling sap soon after it runs, keeping buckets, gathering tanks and storage tanks properly covered to keep out debris, use of germicidal ultraviolet irradiation, cleaning and sanitizing equipment, and filtration of sap by various means.

Methods of food preservation lead to killing of microorganisms (e.g. thermal processes), to physical extraction of microorganisms from the environment (e.g. mechanical processes), to stopping microorganisms growth by eliminating or modifying the parameters needed for growth (e.g. biological processes), to putting them into contact with harmful substances (e.g. chemical processes) or waves (e.g. ionic processes) or electrical impulses (e.g. electrical processes). The processes may be made to conform to the Good Manufacturing Pratices (GMP).

The activity of microorganisms influences the length of time sap can be stored. To increase the safe storage period for sap requires either complete sterilization of the sap (ultraviolet irradiation) or control of the microbial population by keeping it at a low level so that any biochemical changes due to microorganisms in the sap before processing are minimal. Maple sap pasteurization will not overcome spoilage caused by microbial activity occurring in sap collection system. However, if pasteurization is carried out properly and storage conditions are unfavorable for microbial growth, it will maintain the quality of sap during storage for a longer period of time.

Microorganisms in sap range in size from hundreds of microns to less than one micron. Organisms less than 40 microns cannot be seen without the aid of a microscope, while organisms smaller than 1 micron cannot be seen without the use of an electron microscope.

Microorganisms can grow rapidly when conditions are favorable and some species will even grow below freezing point. Growth of microorganisms normally refers to the growth of populations of cells, which is the increase in the number of cells not the growth of individual cells. Limiting and/or reducing the number of microorganisms in sap improves the quality of it and the syrup produced from it will be lighter in color.

Sap may only be collected during a limited period of time each spring. Collecting large volumes of sap and preserving them unspoiled represents a challenge as such large volumes may not be processed all at once due to the limited availability of industrial size sterilization equipment.

There is a need to provide a process for the sterilization and/or pasteurization of sap or sap concentrate without denaturing the proteins and other ingredients present therein.

Furthermore, there is a need for a process for pasteurization of sap or sap concentrate for preserving the sap or sap concentrate until it may be sterilized.

### SUMMARY

According to an embodiment, there is provided a method of sterilization and/or pasteurization of sap or sap concentrate; the improvement characterized in the step of:
a) sterilization treatment of said sap or sap concentrate for a time sufficient to substantially inhibit microbial growth in said sap or sap concentrate with minimal taste alteration, or
   pasteurization treatment of said sap or sap concentrate for a time sufficient to pasteurize, wherein said pasteurization treatment is at least one of a heat pasteurization treatment, a High Temperature Short Time (HTST) treatment, a thermization treatment, a centrifugation treatment, a UV treatment, and combinations thereof, or
   micro-filtration of said sap or sap concentrate with a micro-filter of pore size between about 0.1 μm to about 1 μm, or combinations thereof,
prior to transporting, storing and transporting, transporting and storing, performing a sterilization treatment, or combinations thereof, of said sap or sap concentrate.

The method may be further comprising step b) after step a):
b) sterilization treatment of said sap or sap concentrate for a time sufficient to substantially inhibit microbial growth in said sap or sap concentrate with minimal taste alteration or
desiccation treatment of said sap or sap concentrate for a time sufficient to substantially eliminate water in said sap or sap concentrate.

According to another embodiment, there is provided a method of sterilization and/or pasteurization of sap or sap concentrate; the improvement characterized in the step of:
a) desiccation treatment of said sap or sap concentrate for a time sufficient to substantially eliminate water in said sap or sap concentrate.

The method may be further comprising the step a′) before or after step b):
a′) storing said sap or sap concentrate.

The method may be further comprising the step a″) before or after step b):
a″) transporting said sap or sap concentrate.

The method may be further comprising the step a′″) before or after steps a′):
a′″) transporting said sap or sap concentrate.

The heat pasteurization treatment may be by heating from about 50° C. to at about 100° C. for a time sufficient to pasteurize.

The time sufficient to pasteurize may be from about 10 seconds to about 150 minutes.

The pasteurization treatment may be a High Temperature Short Time (HTST) treatment.

The High Temperature Short Time (HTST) treatment may be from about 70° C. to 100° C. for about 15 seconds to about 30 seconds.

The method of claim 7, wherein the pasteurization treatment may be a thermization treatment.

The thermization treatment may be from about 63° C. to about 65° C., for about 15 to 25 seconds.

The centrifugation treatment may be a bactofugation treatment.

The desiccation may be at least one of a lyophilization, a spray drying, or combinations thereof.

The storing may be at least one of freezing the sap or sap concentrate, refrigerating the sap or sap concentrate, or combinations thereof.

The sterilization treatment may be at least one of a heat sterilization treatment, a dry heat sterilization treatment, a tyndallisation treatment, an upperization treatment, a high pressure processing treatment, canning, a ultrasound treatment, a CO₂ treatment, a UV treatment, a gamma ray treatment, a X-ray treatment, a pulsed light sterilization treatment, a microwave sterilization treatment, a pulsed electric field sterilization, a pulsed magnetic field sterilization, an ozone sterilization treatment, a microfiltration, and combinations thereof.

The heat sterilization treatment may be from about 100° C. to about 160° C. for about 1 seconds to about 60 seconds.

The heat sterilization treatment may be from about 130° C. to about 150° C. for about 2 seconds to about 8 seconds or from about 115° C. to about 137° C. for about 15 minutes to about 130 minutes.

The heat sterilization treatment may be from about 137° C. to about 140° C. for about 2 seconds to about 10 seconds.

The heat sterilization may be performed by contacting the sap or sap concentrate with a heat exchanger.

The heat exchanger may be at least one of a plate heat exchanger, a shell and tube heat exchanger, a double tube heat exchanger, a triple tube heat exchanger, or combinations thereof.

The sterilization treatment may be a high pressure processing (HPP) treatment.

The high pressure processing (HPP) treatment may be from about 999,74 kPa to about 999 739,808 kPa for about 4 minutes to about 30 minutes.

The high pressure processing (HPP) treatment may be at about 599 843,885 kPa for about 15 minutes.

The high pressure processing (HPP) treatment may be at about 599 843,885 kPa for about 6 minutes.

The high pressure processing (HPP) treatment may be at about 599 843,885 kPa for about 4 minutes.

The high pressure processing (HPP) treatment may be performed for a volume of sap or sap concentrate of 1000 L or more.

The high pressure processing (HPP) treatment may be performed by direct or indirect compression.

The tyndallisation treatment may be from about 70° C. to about 100° C., for about 30 mins to about 120 mins, for 3 consecutive days.

The upperization treatment may be from about 140° C. to about 150° C., for about 2 secs to about 3 seconds, followed by homogenization of the sap or sap concentrate.

The UV treatment may be from about 2000 μW s/cm² to about 9500 μW s/cm² of ultraviolet light for a time sufficient to effect sterilization.

The UV treatment may be from about 10 kGy to about 100 kGy.

The UV treatment may be from about 10 kGy or less.

The UV treatment may be from 5 kGy or less.

The gamma ray treatment may be from about 10 kGy to about 100 kGy.

The gamma ray treatment may be from about 1 kGy to about 15 kGy.

The gamma ray treatment may be from about 1 kGy to about 10 kGy.

The X-ray treatment may be from about 10 kGy to about 50 kGy.

The X-ray treatment may be from about 1 kGy to about 15 kGy.

The X-ray treatment may be from about 1 kGy to about 10 kGy.

The pulsed light sterilization treatment may be from about 0.25 J/cm² per pulse, for at least 2 pulses.

The pulsed electric field sterilization may be with an electric field from about 5 kV/cm to about 70 kV/cm, for 5 to 100 pulses of about 2 psec to about 100 psec.

The pulsed magnetic field sterilization may be with a pulsed magnetic field from about 5 Tesla to about 50 Tesla, having a pulse frequency of about 5 to about 500 kHz.

The ozone treatment may be from about 10 mg/L or less of ozone.

The sap or sap concentrate may be produced by a plant chosen from an Acer tree, a birch, a pine, a hickory, a poplar, a coconut from a coconut palm tree (Cocos nucifera), and an agave.

The Acer tree may be chosen from Acer nigrum, Acer lanum, Acer acuminatum, Acer albopurpurascens, Acer argutum, Acer barbinerve, Acer buergerianum, Acer caesium, Acer campbellii, Acer campestre, Acer capillipes, Acer cappadocicum, Acer carpinifolium, Acer caudatifolium, Acer caudatum, Acer cinnamomifolium, Acer circinatum, Acer cissifolium, Acer crassum, Acer crataegifolium, Acer davidii, Acer decandrum, Acer diabolicum, Acer distylum, Acer divergens, Acer erianthum, Acer erythranthum, Acer fabri, Acer garrettii, Acer glabrum, Acer grandidentatum, Acer griseum, Acer heldreichii, Acer henryi, Acer hyrcanum, Acer ibericum, Acer japonicum, Acer kungshanense, Acer kweilinense, Acer laevigatum, Acer laurinum, Acer lobelii, Acer lucidum, Acer macrophyllum, Acer mandshuricum, Acer maximowiczianum, Acer miaoshanicum, Acer micranthum, Acer miyabei, Acer mono, Acer mono×Acer truncatum, Acer monspessulanum, Acer negundo, Acer ningpoense, Acer nipponicum, Acer oblongum, Acer obtusifolium, Acer oliverianum, Acer opalus, Acer palmatum, Acer paxii, Acer pectinatum, Acer pensylvanicum, Acer pentaphyllum, Acer pentapomicum, Acer pictum, Acer pilosum, Acer platanoides, Acer poliophyllum, Acer pseudoplatanus, Acer pseudosieboldianum, Acer pubinerve, Acer pycnanthum, Acer rubrum, Acer rufinerve, Acer saccharinum, Acer saccharum, Acer sempervirens, Acer shirasawanum, Acer sieboldianum, Acer sinopurpurescens, Acer spicatum, Acer stachyophyllum, Acer sterculiaceum, Acer takesimense, Acer tataricum, Acer tegmentosum, Acer tenuifolium, Acer tetramerum, Acer trautvetteri, Acer triflorum, Acer truncatum, Acer tschonoskii, Acer turcomanicum, Acer ukurunduense, Acer velutinum, Acer wardii, Acer×peronai, and Acer×pseudoheldreichii.

According to another embodiment, there is provided a pasteurized or sterilized sap or sap concentrate prepared of the method of the present invention.

The pasteurized or sterilized sap or sap concentrate may comprise saccharose, calcium, potassium, magnesium, sodium, vannilic acid, syringic acid, p-Coumaric acid, malic acid, succinic acid, Alanine, Valine, Proline; Asparagine, and Glutamine.

The pasteurized or sterilized sap or sap concentrate may further comprise at least one of a protein matter, fructose, glucose, an oligosaccharide, a polysaccharide, manganese, phosphorus, aluminum, sulfur, iron, boron, cadmium, molybdenum, selenium, zinc, copper, cis-aconitate, vanillin, hydroxybenzoic acid, syringaldehyde, homovannilic acid, protocatechuic acid, coniferyl aldehyde coniferol, lyoresinol, Isolariciresinol, secoisolariciresinol, dehydroconiferyl alcohol, 5′-methoxy-dehydroconiferyl alcohol, erythro-guaiacylglycerol-b-O-4′-coniferyl alcohol, erythro-guaiacylglycerol-b-O-4′-dihydroconiferyl alcohol, [3-[4-[(6-deoxy-α-L-mannopyranosyl)oxy]-3-methoxyphenyl]methyl]-5-(3,4-dimethoxyphenyl)dihydro-3-hydroxy-4-(hydroxymethyl)-2(3H)-furanone, scopoletin, fraxetin, isofraxidin, gallic acid, ginnalin A (acertannin), ginnalin B, ginnalin C, methyl gallate trimethyl ether, (E)-3,3′-dimethoxy-4,4′-dihydroxy stilbene, ferulic acid, (E)-Coniferyl alcohol, Syringenin, Dihydroconiferyl alcohol, C-veratroylglycol, 2,3-Dihydroxy-1-(4-hydroxy-3,5-dimethoxyphenyl)-1-propanone, 3-Hydroxy-1-(4-hydroxy-3,5-dimethoxyphenyl)propan-1-one, 3′,4′,5′-Trihydroxyacetophenone, 4-Acetylcatechol, 2,4,5-Trihydroxyacetophenone, 1-(2,3,4-trihydroxy-5-methylphenyl)-ethanone, 2-Hydroxy-3′,4′-dihydroxyacetophenone, 4-(dimethoxymethyl)-pyrocatechol, catechaldehyde 3,4-Dihydroxy-2-methylbenzaldehyde, catechol, catechin, epicatechin, fumaric acid, oxalic acid, pyruvic acid, quinic acid, tartaric acid, skimic acid, gluconic acid, lactic acid, acetic acid, sarcosine, glycine, β-amino-isobutyric acid, leucine, allo-isoleucine, isoleucine, arginine, anserine, 3-methyl-histidine, tyrosine, hydroxyl proline, aspartic acid, serine, lysine, threonine, methionine, cysteic acid, Niacin, riboflavin, thiamin, panthothenic acid, choline, vitamin B6, absicissic acid, phaseic acid, auxine, cytokinine, triacontanol, and gibberelline.

The pasteurized or sterilized sap or sap concentrate may comprise:
from about 8.3×10⁻² and up to 1 part saccharose;
from 0.001×10⁻³ and up to 7.8×10⁻³ part calcium;
from 0.001×10⁻³ and up to 7.8×10⁻³ part potassium;
from 0.001×10⁻³ and up to 3.9×10⁻³ part magnesium;
from 0.001×10⁻³ and up to 3.9×10⁻³ part sodium;
from 0.001×10⁻³ and up to 1.6×10⁻³ part vannilic acid;
from 0.001×10⁻³ and up to 1.6×10⁻³ part syringic acid;
from 0.001×10⁻³ and up to 1.6×10⁻³ part p-Coumaric acid;
from 0.001×10⁻¹ and up to 1.0×10⁻¹ of malic acid;
from 0.001×10⁻³ and up to 1.6×10⁻³ part succinic acid;
from 0.001×10⁻³ and up to 7.5×10⁻³ part alanine;
from 0.001×10⁻² and up to 1.6×10⁻² part valine;
from 0.001×10⁻² and up to 1.24×10⁻² part proline;
from 0.001×10⁻² and up to 2.4×10⁻² part asparagine; and
from 0.001×10⁻² and up to 4.7×10⁻² part glutamine.

The pasteurized or sterilized sap or sap concentrate may further comprise:
from 0 and up to 1.6×10⁻³ part of a protein matter;
from 0 and up to 1.5×10⁻¹ part of fructose;
from 0 and up to 1.5×10⁻¹ part of glucose;
from 0 and up to 1.5×10⁻¹ part of an oligosaccharide;
from 0 and up to 1.5×10⁻¹ part of a polysaccharide
from 0 and up to 1.6×10⁻³ part manganese;
from 0 and up to 1.6×10⁻³ part phosphorus;
from 0 and up to 7.8×10⁻⁵ part aluminum;
from 0 and up to 1.6×10⁻³ part sulfur;
from 0 and up to 1.6×10⁻³ part iron;
from 0 and up to 1.6×10⁻³ part boron;
from 0 and up to 1.6×10⁻⁴ part cadmium;
from 0 and up to 1.6×10⁻⁴ part molybdenum;
from 0 and up to 1.6×10⁻⁴ part selenium;
from 0 and up to 1.6×10⁻⁴ part zinc;
from 0 and up to 1.6×10⁻⁴ part copper;
from 0 and up to 1.6×10⁻⁴ part cis-aconitate
from 0 and up to 1.6×10⁻³ part vanillin;
from 0 and up to 1.6×10⁻³ part Hydroxybenzoic acid;
from 0 and up to 1.6×10⁻³ part syringaldehyde;
from 0 and up to 1.6×10⁻³ part homovannilic acid;
from 0 and up to 1.6×10⁻³ part protocatechuic acid;
from 0 and up to 1.6×10⁻³ part coniferyl aldehyde;
from 0 and up to 1.6×10⁻³ part coniferol;
from 0 and up to 1.6×10⁻³ part lyoresinol;
from 0 and up to 1.6×10⁻³ part Isolariciresinol;
from 0 and up to 1.6×10⁻³ part secoisolariciresinol;
from 0 and up to 1.6×10⁻³ part dehydroconiferyl alcohol;
from 0 and up to 1.6×10⁻³ part 5′-methoxy-dehydroconiferyl alcohol;
from 0 and up to 1.6×10⁻³ part erythro-guaiacylglycerol-b-O-4′-coniferyl alcohol;
from 0 and up to 1.6×10⁻³ part erythro-guaiacylglycerol-b-O-4′-dihydroconiferyl alcohol;
from 0 and up to 1.6×10⁻³ part [3-[4-[(6-deoxy-α-L-mannopyranosyl)oxy]-3-methoxyphenyl]methyl]-5-(3,4-dimethoxyphenyl)dihydro-3-hydroxy-4-(hydroxymethyl)-2(3H)-furanone;
from 0 and up to 1.6×10⁻³ part scopoletin;
from 0 and up to 1.6×10⁻³ part fraxetin;
from 0 and up to 1.6×10⁻³ part isofraxidin;
from 0 and up to 1.6×10⁻³ part gallic acid;
from 0 and up to 1.6×10⁻³ part ginnalin A (acertannin);
from 0 and up to 1.6×10⁻³ part ginnalin B;
from 0 and up to 1.6×10⁻³ part ginnalin C;
from 0 and up to 1.6×10⁻³ part methyl gallate trimethyl ether;
from 0 and up to 1.6×10⁻³ part (E)-3,3′-dimethoxy-4,4′-dihydroxy stilbene;
from 0 and up to 1.6×10⁻³ part ferulic acid;
from 0 and up to 1.6×10⁻³ part (E)-Coniferyl alcohol;
from 0 and up to 1.6×10⁻³ part syringenin;
from 0 and up to 1.6×10⁻³ part dihydroconiferyl alcohol;
from 0 and up to 1.6×10⁻³ part C-veratroylglycol;
from 0 and up to 1.6×10⁻³ part 2,3-Dihydroxy-1-(4-hydroxy-3,5-dimethoxyphenyl)-1-propanone;
from 0 and up to 1.6×10⁻³ part 3-Hydroxy-1-(4-hydroxy-3,5-dimethoxyphenyl)propan-1-one;
from 0 and up to 1.6×10⁻³ part 3′,4′,5′-Trihydroxyacetophenone;
from 0 and up to 1.6×10⁻³ part 4-Acetylcatechol;
from 0 and up to 1.6×10⁻³ part 2,4,5-Trihydroxyacetophenone;
from 0 and up to 1.6×10⁻³ part 1-(2,3,4-trihydroxy-5-methylphenyl)-ethanone;
from 0 and up to 1.6×10⁻³ part 2-Hydroxy-3′,4′-dihydroxyacetophenone;
from 0 and up to 1.6×10⁻³ part 4-(dimethoxymethyl)-pyrocatechol;
from 0 and up to 1.6×10⁻³ part Catechaldehyde;
from 0 and up to 1.6×10⁻³ part 3,4-Dihydroxy-2-methylbenzaldehyde;
from 0 and up to 1.6×10⁻³ part catechol;
from 0 and up to 1.6×10⁻³ part catechin;
from 0 and up to 1.6×10⁻³ part epicatechin;
from 0 and up to 1.6×10⁻³ part fumaric acid;
from 0 and up to 1.6×10⁻³ part oxalic acid;
from 0 and up to 1.6×10⁻³ part pyruvic acid;
from 0 and up to 1.6×10⁻³ part quinic acid;
from 0 and up to 1.6×10⁻⁴ part tartaric acid;
from 0 and up to 1.6×10⁻⁴ part skimic acid;
from 0 and up to 1.6×10⁻³ part gluconic acid;
from 0 and up to 1.6×10⁻³ part lactic acid;
from 0 and up to 1.6×10⁻³ part acetic acid;
from 0 and up to 1.6×10⁻³ part sarcosine;
from 0 and up to 7.5×10⁻³ part glycine;
from 0 and up to 1.6×10⁻³ part β-amino-isobutyric acid;
from 0 and up to 1.3×10⁻³ part leucine;
from 0 and up to 4.7×10⁻³ part allo-isoleucine;
from 0 and up to 2.3×10⁻² part isoleucine;
from 0 and up to 4.7×10⁻² part arginine;
from 0 and up to 4.7×10⁻² part anserine;
from 0 and up to 4.7×10⁻² part 3-methyl-histidine;
from 0 and up to 4.7×10⁻² part tyrosine
from 0 and up to 4.7×10⁻² part hydroxyl proline;
from 0 and up to 4.7×10⁻² part aspartic acid;
from 0 and up to 4.7×10⁻² part serine;
from 0 and up to 4.7×10⁻² part lysine;
from 0 and up to 4.7×10⁻² part threonine;
from 0 and up to 4.7×10⁻² part methionine;
from 0 and up to 4.7×10⁻² part cysteic acid
from 0 and up to 1.0×10⁻³ part niacin;
from 0 and up to 5.0×10⁻³ part riboflavin;
from 0 and up to 1.0×10⁻³ part thiamin;
from 0 and up to 1.0×10⁻³ part panthothenic acid;
from 0 and up to 5.0×10⁻³ part choline;
from 0 and up to 1.0×10⁻³ part vitamin B6;
from 0 and up to 3.1×10⁻³ part absicissic acid;
from 0 and up to 6.2×10⁻³ part phaseic acid;
from 0 and up to 3.9×10⁻³ part auxine;
from 0 and up to 1.6×10⁻³ part cytokinine;
from 0 and up to 1.6×10⁻³ part Triacontanol; and
from 0 and up to 1.6×10⁻⁴ part gibberelline.

The pasteurized or sterilized sap or sap concentrate may be further comprising a preservative.

The preservative may be chosen from propanoic acid, sodium propanoate, calcium propanoate, potassium propanoate, sorbic acid, sodium sorbate, potassium sorbate, and calcium sorbate, benzoic acid, sodium benzoate, potassium benzoate, and calcium benzoate, a paraben, a sulfite, ethylene oxide, propylene oxide, sodium diacetate, dehydroacetic acid, sodium nitrite, caprylic acid, ethyl formate, disodium EDTA, methylchloroisothiazolinone, an antioxidant vitamin C, vitamin E, any suitable food preservatives and any combinations thereof.

The paraben may be chosen from butylparaben, ethylparaben, heptylparaben, methylparaben, propylparaben, or combinations thereof.

The sulfite may be chosen from caustic sulphite caramel, sulphite ammonia caramel, Sodium sulphite, Sodium bisulphite, Sodium metabisulphite, potassium metabisulphite, potassium sulphite, calcium sulphite, calcium hydrogen sulphite, potassium hydrogen sulphite, or combinations thereof.

The antioxidant may be chosen from ascorbic acid, tocopherol, propyl gallate, tertiary butylhydroquinone, butylated hydroxyanisole, butylated hydroxytoluene, or combinations thereof.

According to another embodiment, there may be provided a food or food ingredient comprising the pasteurized or sterilized sap or sap concentrate of the present invention.

The food may be a beverage.

According to another embodiment, there is provided a food prepared by sterilizing and/or pasteurizing a pasteurized or sterilized sap or sap concentrate of the present invention, combined with at least one food ingredient.

The sterilizing and/or pasteuring may be at least one of a heat sterilization treatment, a dry heat sterilization treatment, a tyndallisation treatment, an upperization treatment, a high pressure processing treatment, canning, a UV treatment, a gamma ray treatment, a X-ray treatment, a pulsed light sterilization treatment, a microwave sterilization treatment, a pulsed electric field sterilization, a pulsed magnetic field sterilization, an ozone sterilization treatment, a microfiltration, a pasteurization treatment, a High Temperature Short Time (HTST) treatment, a thermization treatment, and combinations thereof.

The at least one food ingredient may be chosen from a fruit, a vegetable, a fruit mixture, a vegetable mixture, a fruit puree, a vegetable puree, a fruit powder, a vegetable powder, a fruit concentrate, a vegetable concentrate, a juice, an alcool, a liquid, a spice, a flavoring agent, a vitamin, an amino acid, an oil, a fat, a vinegar, a dairy ingredient, a bacterial culture, a probiotic culture, a egg derived ingredient, a dietary fiber, any other suitable food ingredient, and combinations thereof.

According to another embodiment, there is provided a culture medium comprising a pasteurized or sterilized sap or sap concentrate the present invention.

The culture medium may be a liquid culture medium.

The culture medium may be a solid culture medium.

The culture medium may be a microorganism culture medium, a prokaryotic cell culture medium, a eukaryotic cell culture medium, or a plant culture medium.

According to another embodiment, there is provided a cosmetic composition comprising the pasteurized or sterilized sap or sap concentrate of the present invention in association with at least one cosmetic ingredient.

According to another embodiment, there is provided a desiccated sap or sap concentrate obtained according to the process of the present invention.

The following terms are defined below.

The term “sap” is intended to mean a sap produce by a plant chosen from Acer tree, birch, pine, hickory, poplar, palm tree, and agave.

The term “Acer tree” or a “maple tree” is intended to mean a maple tree of a species known to date, such as Acer nigrum, Acer lanum, Acer acuminatum, Acer albopurpurascens, Acer argutum, Acer barbinerve, Acer buergerianum, Acer caesium, Acer campbellii, Acer campestre, Acer capillipes, Acer cappadocicum, Acer carpinifolium, Acer caudatifolium, Acer caudatum, Acer cinnamomifolium, Acer circinatum, Acer cissifolium, Acer crassum, Acer crataegifolium, Acer davidii, Acer decandrum, Acer diabolicum, Acer distylum, Acer divergens, Acer erianthum, Acer erythranthum, Acer fabri, Acer garrettii, Acer glabrum, Acer grandidentatum, Acer griseum, Acer heldreichii, Acer henryi, Acer hyrcanum, Acer ibericum, Acer japonicum, Acer kungshanense, Acer kweilinense, Acer laevigatum, Acer laurinum, Acer lobelii, Acer lucidum, Acer macrophyllum, Acer mandshuricum, Acer maximowiczianum, Acer miaoshanicum, Acer micranthum, Acer miyabei, Acer mono, Acer mono×Acer truncatum, Acer monspessulanum, Acer negundo, Acer ningpoense, Acer nipponicum, Acer oblongum, Acer obtusifolium, Acer oliverianum, Acer opalus, Acer palmatum, Acer paxii, Acer pectinatum, Acer pensylvanicum, Acer pentaphyllum, Acer pentapomicum, Acer pictum, Acer pilosum, Acer platanoides, Acer poliophyllum, Acer pseudoplatanus, Acer pseudosieboldianum, Acer pubinerve, Acer pycnanthum, Acer rubrum, Acer rufinerve, Acer saccharinum, Acer saccharum, Acer sempervirens, Acer shirasawanum, Acer sieboldianum, Acer sinopurpurescens, Acer spicatum, Acer stachyophyllum, Acer sterculiaceum, Acer takesimense, Acer tataricum, Acer tegmentosum, Acer tenuifolium, Acer tetramerum, Acer trautvetteri, Acer triflorum, Acer truncatum, Acer tschonoskii, Acer turcomanicum, Acer ukurunduense, Acer velutinum, Acer wardii, Acer×peronai, Acer×pseudoheldreichii or any new species not yet known.

The term “palm tree” is intended to mean a coconut palm tree (Cocos nucifera) from which coco water may be obtained from the coconuts.

The term “pasteurization” is intended to mean the reduction of the number of viable pathogens in a product so they are unlikely to cause disease (assuming the pasteurized product is stored as indicated and consumed before its expiration date). Commercial-scale sterilization of food is not common because it adversely affects the taste and quality of the product. Preferably the pasteurization does not affect the taste or texture of the product.

The term “sterilization” is intended to mean a procedure that kills all spore, microorganisms, yeasts, molds. In the context of food, the procedure is functional irrespective of the pH of the medium. It allows the preservation of the product for a long time (months).

The term “desiccation” is intended to mean a procedure that substantially removes water from a substance or product. The obtained desiccated product may be for example a dry powder or solid that may be reconstituted through the addition of water. It allows the preservation of the product for a long time (months or years).

The term “storing” is intended to mean keeping or accumulating the maple sap or sap concerntrate for future use, for example in tanks, barrels, silos, bags, or any suitable means of storage for a fluid. The means of storage may or may not be refrigerated or frozen.

The term “transporting” is intended to mean the action of moving the sap or sap concentrate from one place to another. Transportation may be through tubing or pipes, or in large containers such as tanks, barrels, or the likes, to bring the sap or sap concentrate to facilities where they may be stored and/or processed, for example, by a further sterilization treatment, processed into maple syrup, or other maple derived products, etc.

Features and advantages of the subject matter hereof will become more apparent in light of the following detailed description of selected embodiments, as illustrated in the accompanying figures. As will be realized, the subject matter disclosed and claimed is capable of modifications in various respects, all without departing from the scope of the claims. Accordingly, the drawings and the description are to be regarded as illustrative in nature, and not as restrictive and the full scope of the subject matter is set forth in the claims.

### BRIEF DESCRIPTION OF THE DRAWINGS

Further features and advantages of the present disclosure will become apparent from the following detailed description, taken in combination with the appended drawings, in which:

FIG. 1 illustrates the results of a pasteurization treatment of maple sap compared to untreated maple sap (raw material).

FIG. 2 illustrates the results of a bactofugation treatment of maple sap compared to untreated maple sap (raw material).

FIG. 3 illustrates the results of a UV treatment of maple sap compared to untreated maple sap (raw material).

FIG. 4 illustrates the results of a UV treatment of maple sap compared to untreated maple sap (raw material).

### DETAILED DESCRIPTION

In a first embodiment there is disclosed a method of sterilization and/or pasteurization of sap or sap concentrate characterized in the step of:
a) sterilization treatment of said sap or sap concentrate for a time sufficient to substantially inhibit microbial growth in said sap or sap concentrate with minimal taste alteration, or
   pasteurization treatment of said sap or sap concentrate for a time sufficient to pasteurize, wherein said pasteurization treatment is at least one of a heat pasteurization treatment, a High Temperature Short Time (HTST) treatment, a thermization treatment, a centrifugation treatment, a UV treatment, and combinations thereof, or
   micro-filtration of said sap or sap concentrate with a micro-filter of pore size between about 0.1 μm to about 1 μm, or combinations thereof,
prior to transporting, storing and transporting, transporting and storing, performing a sterilization treatment, or combinations thereof, of said sap or sap concentrate.

In a second embodiment, there is disclosed a method of sterilization and/or pasteurization of sap or sap concentrate; the improvement characterized in the step b after step a:
b) sterilization treatment of the sap or sap concentrate for a time sufficient to substantially inhibit microbial growth in the sap or sap concentrate with minimal taste alteration or desiccation treatment of the sap or sap concentrate for a time sufficient to substantially eliminate water in the sap or sap concentrate.

In a third embodiment, there is disclosed a method of desiccating a sap or sap concentrate comprising the step of:
a) desiccation treatment of the sap or sap concentrate for a time sufficient to substantially eliminate water in the sap or sap concentrate.

### Inactivation of Endogenous Flora

It is essential to inactivate endogenous flora (microorganisms present in the sap collected) by a pasteurization and/or sterilization treatment, or a micro-filtration treatment that does not alter the endogeous nutraceutical compounds or the intrinsic qualities of the sap. One or more of these treatment may be performed prior to transporting the sap or sap concentrate, storing and transporting, or transporting and storing the sap or sap concentrate, or performing a further sterilization treatment of the sap or sap concentrate.

Inactivating the endogenous flora of sap or sap concentrate allow them to be stored at, and/or transported to another site for later treatment or transformation. Sap and sap concentrate are excellent growth medium for microorganism, and the process of the present invention is useful for collecting large volumes of these fluids and preserving them unspoiled until they can be further processed.

### Pasteurization

Pasteurization relies on the principle that most harmful microorganisms can be killed by heat. The most effective way to kill most microorganisms is by boiling, but this compromises the flavor of the liquid. Pasteurization strikes a median happy balance between boiling and not boiling the sap, keeping the flavor delicious while making the food safer. In addition to minimizing the risk of sickness and intoxication, pasteurization also makes foods more shelf stable.

According to an embodiment of the present invention, the liquid may be pasteurized using any suitable pasteurization method known in the art. Preferably, the pasteurization method will be one that minimizes or does not alter the organoleptic qualities of the liquid being treated, such as the taste, texture, etc. The liquid may be pasteurized at several temperatures, for example at about 121° C. for at least about 10 minutes. According to some embodiment, the pasteurization temperature may be a temperature may be from about 50° C. to about 121° C. or from about 55° C. to about 121° C. Preferably, the pasteurization temperature may be from about 50° C. to about 100° C. and most preferably from about 50° C. to about 100° C. for preserving the organoleptic qualities of the liquid. The pasteurization step may be performed for a time sufficient to achieve the pasteurization effect (i.e. a reduction of the microbial load of the liquid). The period of time necessary for pasteurization may vary greatly depending on the technology employed for the pasteurization, for example flash pasteurization, cold pasteurization, or other such techniques. The time may range from a few seconds or minutes of exposure to a specified temperature. For example, a fluid may be exposed to the pasteurization temperature in an apparatus having a large surface of area of exposure allowing to bring the whole volume of liquid rapidly to the desired temperature and achieve the pasteurization. Alternatively, the volume of liquid being pasteurized may be heated in a tank and require longer period of time for achieving pasteurization. According to some embodiment of the present invention, the pasteurization methods are two primary methods of pasteurization: the liquid can be heated to about 55° C. and held there for at least about 20 minutes, or the liquid can be pasteurized at about 80° C. for a minimum of about 10 minutes. According to yet another embodiment, the pasteurization may also be accomplished by heating the liquid at about 50° C. to about 100° C., for about 10 seconds to about 30 minutes. According to another embodiment, the pasteurization treatment may be a High Temperature Short Time (HTST) treatment, where the liquid can be in a continuous flow while subjected to temperatures of about 71.5° C. to 74° C. for about 15 to 30 seconds. According to another embodiment, the pasteurization treatment may be a thermization treatment, where the liquid can be subjected to temperatures of about 63° C. to about 65° C., for about 15 to 25 seconds.

However, the pasteurization may be performed over a preferred range of temperature and time that range from about 50° C. for at least about 30 minutes, or from about 55° C. for at least about 20 minutes, to about 80° C. for at least about 10 minutes. For example, the temperature and time may be from about 50° C. for at least about 30 minutes, or from about 51° C. for about at least about 30 minutes, or from about 52° C. for about at least about 28 minutes, or from about 53° C. for about at least about 26 minutes, or from about 54° C. for about at least about 24 minutes, about 55° C. for at least about 20 minutes, or about 56° C. for at least about 20 minutes, or about 57° C. for at least about 20 minutes, or about 58° C. for at least about 20 minutes, or about 59° C. for at least about 20 minutes, or about 60° C. for at least about 20 minutes, or about 61° C. for at least about 20 minutes, or about 62° C. for at least about 20 minutes, or about 63° C. for at least about 20 minutes, or about 64° C. for at least about 20 minutes, or from about 64° C. for at least about 19 minutes, or from about 65° C. for at least about 19 minutes, or from about 66° C. for at least about 19 minutes, or from about 66° C. for at least about 18 minutes, or from about 67° C. for at least about 18 minutes, or from about 68° C. for at least about 17 minutes, or from about 69° C. for at least about 17 minutes, or from about 69° C. for at least about 16 minutes, or from about 70° C. for at least about 16 minutes, or from about 71° C. for at least about 16 minutes, or from about 69° C. for at least about 15 minutes, or from about 72° C. for at least about 15 minutes, or from about 73° C. for at least about 14 minutes, or from about 69° C. for at least about 16 minutes, or from about 74° C. for at least about 14 minutes, or from about 74° C. for at least about 13 minutes, or from about 75° C. for at least about 13 minutes, or from about 76° C. for at least about 13 minutes, or from about 76° C. for at least about 12 minutes, or from about 77° C. for at least about 12 minutes, or from about 78° C. for at least about 11 minutes, or from about 79° C. for at least about 11 minutes, or from about 79° C. for at least about 10 minutes, or from about 80° C. for at least about 10 minutes. The temperature and length of the pasteurization treatment may be chosen depending on several factors. For example, in industrial scale setting, the systems in place may employ a system where the pasteurization is performed at about 80° C. for at least about 10 minutes. In sugar house setting, the pasteurization is performed at about 63° C. for at least about 20 minutes, which are conditions less demanding energetically for small scale operations. For sugar house systems, a 0.5° C. increase in temperature may be suggested to enable lower energy cost treatments, at a lower temperature for a longer time (e.g. 63° C. for about 20 minutes). Pasteurization reactions performed at temperatures above 80° C. for at least about 10 minutes cause Maillard reaction in the liquid, that bring about chemical changes in the liquid and change the taste of the final product. These may affect the organoleptic qualities of the sap or sap concentrate and are usually undesirable, depending on the final commercial use of the sap or sap concentrate. Pasteurization can be done using a continuous method, where the liquid flows through a pasteurization system, or by using a batch method, where one batch of the liquid is pasteurized at a time. Continuous pasteurization is popular for large producers, because it does not slow the supply line as much as batch pasteurization does.

According to another embodiment, the pasteurization treatment may be a centrifugation treatment. According to a preferred embodiment, the centrifugation treatment may be a bactofugation treatment. Centrifugation/bactofugation are the removal of microbial cells of high density from a liquid using high centrifugal force. These methods are most efficient against microbial cells of high density, especially bacterial spores and somatic cells.

This process is used to eliminate the bacteria contained in the liquid by means of centrifugal force. The effectiveness of bactofugation increases with the temperature of the liquid, and varies as a function of the size and type of bacteria, because sedimentation by centrifugal force is greater for larger and denser bacterial cells. It has been found that, on average, liquid treated in a bactofuge contains 90% fewer germs than the original liquid. Bactofugation is a process which is specifically designed to separate micro-organisms from liquids. Bactofugation is an efficient method of removing heat resistant spores from milk for example. The bactofuge technology can make a useful complement to thermization, pasteurization and sterilization.

A hermetic centrifuge called a bactofuge is employed as the main unit to carry out the separation of the bacterial cells and their spores. There are three main methods of bactofugation:
1—Two-phase bactofuge with continuous discharge of the bactofugate;
2—single-phase bactofugate with intermitent discharge of the bactofugate;
3—double bactofugation with two single-phase bactofugates in series.

The bactofuge separates the bactofugate, which is rich in spores and other microbial cells, as it is denser than the rest of the liquid.

### Desiccation

According to another embodiment of the present invention, the sap or sap concentrate may be desiccated. Desiccation is the state of extreme dryness, or the process of extreme drying. According to an embodiment, the sap or sap concentrate may be desiccated by lyophilization. According to another embodiment, the sap or sap concentrate may be desiccated by spray drying. According to yet another embodiment, the sap or sap concentrate may be desiccated by a combination of spray drying and lyophilization.

Lyophilization, which is also known as Freeze-drying or cryodesiccation, is a dehydration process typically used to preserve a perishable material or make the material more convenient for transport. Freeze-drying works by freezing the material and then reducing the surrounding pressure to allow the frozen water in the material to sublimate directly from the solid phase to the gas phase, and yield a dry solid or powder.

Spray drying is a method of producing a dry powder from a liquid or slurry by rapidly drying with a hot gas. This is the preferred method of drying of many thermally-sensitive materials such as foods and pharmaceuticals. Air is the heated drying medium; however, if the liquid or the product is oxygen-sensitive then nitrogen may be used.

All spray dryers use some type of atomizer or spray nozzle to disperse the liquid or slurry into a controlled drop size spray. The most common of these are rotary disks and single-fluid high pressure swirl nozzles. Alternatively, for some applications two-fluid or ultrasonic nozzles are used. Depending on the process needs, drop sizes from 10 to 500 μm can be achieved with the appropriate choices. The most common applications are in the 100 to 200 μm diameter range. The obtained dry powder is often free-flowing.

The obtained dry solid or powder may be packaged in sealed packages which may or may not be vacuum sealed.

### Sterilization

According to another embodiment of the present invention, the liquid may be sterilized using any suitable sterilization method know in the art, while having minimal taste alteration, for preserving the organoleptic qualities of the liquids. According to an embodiment, the sterilization of the sap or sap concentrate may be performed for a time sufficient to eliminate microbial life in the sap or sap concentrate with minimal taste alteration, for preserving the organoleptic qualities of the liquids. As used herein, time sufficient is intended to mean the time necessary to greatly reduce and preferably eliminate the microbial life in the sap or sap concentrate with minimal taste alteration.

The heat sterilization treatment may be performed from about 100° C. to about 160° C. for about 1 seconds to about 60 seconds, or from about 130° C. to about 150° C. for about 2 seconds to about 8 seconds or from about 137° C. to about 140° C. for about 2 seconds to about 10 seconds, or for at least one of 131° C. for 14 seconds, 138° C. for 4 seconds, and 145° C. for 2 seconds, or from about 115° C. to about 137° C. for about 15 to about 130 minutes.

According to another embodiment, the sterilization treatment may be performed by a tyndallisation treatment. Tyndallization essentially consists of heating the sap or sap concentrate for 30 to 60 minutes for three days in a row (usually by boiling it). On the second day most of the spores that survived the first day will have germinated into bacterial cells. These cells will be killed by the second day's heating. The third day kills bacterial cells from late-germinating spores. During the waiting periods over the three days, the substance being sterilized is kept at a warm room temperature; i.e., a temperature that is conducive to germination of the spores. Germination also requires a moist environment. When the environment is conducive to the formation of cells from spores, the formation of spores from cells does not occur. The Tyndallization process is generally effective, but its reliability is not considered 100% certified. Thus, tyndallization is performed from about 70° C. to about 100° C., for about 30 minutes to about 60 minutes, for 3 consecutive days.

According to another embodiment, the sterilization treatment may also be performed by an upperization treatment. This technique uses intense heat (water vapor stream at 140° C. to 150° C.) for a few seconds (2-3 seconds), and is followed by homogenization. It allows a liquid to be preserved for about 5 to about 6 months, without the affecting the flavor, and lessen the loss of vitamins. It has the disadvantages of requiring a lot of energy. The liquid is sprayed in the form of small droplets, for a very short time at very high temperatures, (eg, 2 seconds at 150° C.), with a stream of saturated water vapor. Contact with the heat is uniform over the droplet propelled into heat and microbial loads can be destroyed more easily than for the bulk pasteurization process. Thus, the upperization treatment is from about 140° C. to about 150° C., for about 2 seconds to about 3 seconds, followed by homogenization of the sap or sap concentrate.

The heat sterilization treatment, or any of the treatment types requiring heating of the sap or sap concentrate may be performed by contacting the sap or sap concentrate with heating means which bring the liquid to the desired temperature very rapidly. The period of time necessary for sterilization may vary greatly depending on the technology employed for the sterilization by heat treatment. The time may range from a few seconds or minutes of exposure to a specified temperature. For example, a fluid may be exposed to the sterilization temperature in an apparatus having a large surface of area of exposure allowing to bring the whole volume of liquid rapidly to the desired temperature and achieve the sterilization. Examples include heat exchangers through which the liquid flows and is brought to the desired temperature almost instantaneously, as the volume of contact of the fluid and the heat exchanger apparatus is very small during the flow of the liquid through the apparatus. Examples of heat exchanger include heat exchanger suitable for the processing of food, such as plate heat exchangers, shell and tube heat exchangers, double tube heat exchangers, triple tube heat exchangers, or combinations thereof. The sap or sap concentrate may be boiled for a period of time.

According to another embodiment, the sterilization treatment may also be a high pressure processing (HPP) treatment (also known as pascalization). HPP treatment stops chemical activity caused by microorganisms that play a role in the deterioration of foods. The treatment occurs at low temperatures and does not include the use of food additives. The treatment may be conveniently used in the treatment of food, including sap and sap concentrate, as it does not alter the taste, texture, or color of the products, but the shelf life of the product is increased. However, some treated foods still require cold storage because pascalization does not stop all enzyme activity caused by proteins, and may also not kill all microorganisms.

According to an embodiment, HPP is performed from about 999,74 kPa to about 999 739.808 kPa for about 4 minutes to about 30 minutes, or from about 344 737.865 kPa to about 599 843.885 kPa for about 4 minutes to about 30 minutes. According to another embodiment, HPP is performed 599 843.885 kPa for about 15 minutes, or at about 599 843.885 kPa for about 6 minutes, and according to another embodiment it is performed at about 599 843.885 kPa for about 4 minutes. According to another embodiment, HPP may be performed for volumes of sap or sap concentrate up to 1000 L.

The HPP treatment can also be combined with another sterilization and/or pasteurization treatment. For example, HPP may be used conventionally to sterilize the sap or sap concentrate, while an optional second treatment could be pre-heat treating of the sap or sap concentrate, freezing, or it may be subjected twice to different pressures. According to another embodiment, the sterilization and/or pasteurization treatment may be done at different time in the self-life of the sap or sap concentrate. For example, the sap or sap concentrate could be pasteurized, and after few days it could be subjected to HPP.

Ultraviolet light treatment, as well as other mode of sterilization involving radiation, such as gamma ray sterilization treatment and X-ray sterilization treatment, as other methods of sterilization that may be used in the method of the present invention. Suitable UV treatment may be achieved by subjecting the sap or sap concentrate to about 2000 μW s/cm² to about 8000 μW s/cm² of ultraviolet light as a microbicide treatment. Suitable UV treatment may also be achieved by subjecting the sap or sap concentrate to a UV treatment of about more than 10 kGy to 50 kGy to destroy all microorganisms, to a UV treatment about 10 kGy or less, which is suitable to kill all pathogens that did not sporulate; it may also be achieved by subjecting the sap or sap concentrate to a UV treatments about 5 kGy or less without altering the product. Preferably, the dose of UV irradiation is limited to 17.5 kGy for organoleptic reasons.

Suitable gamma ray treatment may be achieved by subjecting the sap or sap concentrate to a gamma ray treatment from about 1 kGy to about 50 kGy, or from about 1 kGy to about 15 kGy, or from about 1 kGy to about 10 kGy. Preferably, the dose of the gamma ray treatment is limited to 17.5 kGy for organoleptic reasons.

Suitable X-ray treatment may be achieved by subjecting the sap or sap concentrate to an X-ray treatment from about 1 kGy to about 50 kGy, or from about 1 kGy to about 15 kGy, or from about 1 kGy to about 10 kGy. Preferably, the dose of the gamma ray treatment is limited to 17.5 kGy for organoleptic reasons.

According to another embodiment, the sterilization may also be achieved with a pulsed light sterilization treatment. This method is based on a number of very intense flashes of light emitted for example by a quartz lamp containing xenon. The intense flash of light emitted by the lamp is focused on the surface to be treated by a reflector. This emits a light of wavelengths between 200 nm in the ultraviolet and 1 mm in the near infrared. This feature of the spectrum, the extremely short pulses (10⁻⁶ to 0.1 seconds) and intensity of the energy released, provide the pulsed light sterilization treatment with its sterilizing properties. This intensity represents more than 20,000 times sunlight on the surface of the earth. According to an embodiment, the pulsed light sterilization treatment may be from about 0.25 J/cm² per pulse, for at least 2 pulses.

According to another embodiment, the sterilization may also be achieved with a pulsed electric field sterilization. The process of pulsed electric fields applied to the food industry, is to subject the food to electric fields of very high intensity (5 to 70 kV/cm), repeatedly (pulsed), for very short times (of order of a microsecond), in order to destroy the microorganisms contained therein.

Exposure of a microorganism to a pulsed electric field high enough, leads to a phenomenon of membrane permeabilization. This break known as electroporation, may be reversible if the field strength and exposure time are moderate, but if these values increase sharply, membrane rupture is irreversible and it is the death of the microorganism. According to an embodiment, pulsed electric field sterilization may be performed with an electric field from about 5 kV/cm to about 70 kV/cm, for 5 to 100 pulses of about 2 psec to about 100 psec.

According to another embodiment, the sterilization may also be achieved with a pulsed magnetic field sterilization. The effects of magnetic fields on microorganisms are still unknown and several theories have been proposed, but to date the mode of action of pulsed magnetic fields on microorganisms is not well understood. One hypothesis is that the magnetic field created in the travel position of the ions within the membrane, and can open or close membrane channels, and/or impart a torsional force on the dipoles membrane, resulting in localized fractures. A pulsed field from 5 to 50 T, at a pulse frequency of between 5 and 500 kHz, allows to get reductions of at least two order of magnitude of the populations of pathogens in different foods.

Therefore, according to an embodiment, the pulsed magnetic field sterilization may be performed with a pulsed magnetic field from about 5 Tesla to about 50 Tesla, having a pulse frequency of about 5 to about 500 kHz.

According to yet another embodiment, the sterilization may also be achieved with an ozone treatment. The typical concentrations of ozone used for the treatment of food by the ambient air, such as in cold rooms, are of the order of 2 to 7 ppm. For the treatment of water, a concentration of 10 mg/L or less of ozone is as effective as a chlorine dose of 200 mg/L in destroying a wide range of pathogens. According to an embodiment, the ozone treatment may be performed with about 10 mg/L or less of ozone.

In a particular aspect of the invention, the sterilization and/or pasteurization step involves processing the filtered sap at a temperature of less than about 121° C. It should be noted that the present invention contemplates the use of the various other sterilization and/or pasteurization methods used in the food industry. The sterilization and/or pasteurization step may be performed with any suitable heating/pasteurization system that may be adapted for the heating of the filtered sap. According to some embodiment, non-limiting examples of heating systems that may be suitably adapted to the sterilization and/or pasteurization process of the present invention include electric heating systems, combustion heating system (e.g. through combustion of oil, light oil, natural gas, gasoline, kerosene, wood, or any other suitable fuels), radiation heating systems (e.g. infrared, solar), dielectric heating (microwave heating), The specific temperature and time based food treatment methods described herein are not meant to be exhaustive, but rather indicative that maple based products may be made based on conventional food treatment methods.

According to another embodiment, the method of the present invention may also include the step a′) before or after step b):
a′) storing the sap or sap concentrate.

According to an embodiment, the storing is at least one of freezing the sap or sap concentrate, refrigerating the sap or sap concentrate, or combinations thereof.

Sap, in particular maple sap may often only be collected during a specific period of time during a year (e.g. spring). Therefore, large quantities of sap may be collected but not sterilized sufficiently rapidly before it spoils and becomes unfit for consumption. For example, the sterilization equipment may not be available in due time before the sap spoils. Thus, after an initial pasteurization treatment, the sap can be stored until the sterilization equipment becomes available for processing the sap.

According to another embodiment, the method of the present invention may also include step a″) before or after step b):

a″) transporting the sap or sap concentrate.

According to another embodiment, the method of the present invention may also include step a′″) before or after steps a′):

a′″) transporting the sap or sap concentrate.

Sap or sap concentrate is collected at the farm, and may be pasteurized on site. However, sterilization equipment may be too expensive to purchase and maintain for sterilization of sap for a short seasonal period when such equipment is required. Therefore, according to an embodiment, the sap or sap concentrate may be transported to a specialized facility where it may be sterilized. For example, the sap or sap concentrate may be loaded into a tanker truck for transportation to the sterilization facility.

### Pasteurized or Sterilized Sap or Sap Concentrate and Other Products

According to another embodiment of the present invention, there is disclosed a pasteurized sap or sap concentrate prepared according to the method described above. According to one embodiment, the pasteurized sap or sap concentrate may comprise, saccharose, calcium, potassium, magnesium, sodium, vannilic acid, syringic acid, p-Coumaric acid; malic acid; succinic acid; alanine; valine, proline; asparagine; and glutamine. Also, according to another embodiment, the pasteurized sap or sap concentrate according to the present invention may also further comprise at least one of a protein matter, fructose, glucose, an oligosaccharide, a polysaccharide, manganese, phosphorus, aluminum, sulfur, iron, boron, cadmium, molybdenum, selenium, zinc, copper, cis-aconitate, vanillin, hydroxybenzoic acid, syringaldehyde, homovannilic acid, protocatechuic acid, coniferyl aldehyde coniferol, lyoresinol, Isolariciresinol, secoisolariciresinol, Dehydroconiferyl alcohol, 5′-methoxy-dehydroconiferyl alcohol, erythro-guaiacylglycerol-b-O-4′-coniferyl alcohol, erythro-guaiacylglycerol-b-O-4′-dihydroconiferyl alcohol, [3-[4-[(6-deoxy-α-L-mannopyranosyl)oxy]-3-methoxyphenyl]methyl]-5-(3,4-dimethoxyphenyl)dihydro-3-hydroxy-4-(hydroxymethyl)-2(3H)-furanone, scopoletin, fraxetin, isofraxidin, gallic acid, ginnalin A (acertannin), ginnalin B, ginnalin C, methyl gallate trimethyl ether, (E)-3,3′-dimethoxy-4,4′-dihydroxy stilbene, ferulic acid, (E)-Coniferyl alcohol, syringenin, dihydroconiferyl alcohol, C-veratroylglycol, 2,3-Dihydroxy-1-(4-hydroxy-3,5-dimethoxyphenyl)-1-propanone, 3-Hydroxy-1-(4-hydroxy-3,5-dimethoxyphenyl)propan-1-one, 3′,4′,5′-Trihydroxyacetophenone, 4-Acetylcatechol, 2,4,5-Trihydroxyacetophenone, 1-(2,3,4-trihydroxy-5-methylphenyl)-ethanone, 2-Hydroxy-3′,4′-dihydroxyacetophenone, 4-(dimethoxymethyl)-pyrocatechol, Catechaldehyde 3,4-Dihydroxy-2-methylbenzaldehyde, catechol, catechin, epicatechin, fumaric acid, oxalic acid, pyruvic acid, quinic acid, tartaric acid, skimic acid, gluconic acid, lactic acid, acetic acid, sarcosine, glycine, β-amino-isobutyric acid, leucine, allo-isoleucine, isoleucine, arginine, anserine, 3-methyl-histidine, tyrosine, hydroxyl proline, aspartic acid, serine, lysine, threonine, methionine, cysteic acid, niacin, riboflavin, thiamin, panthothenic acid, choline, vitamin B6, absicissic acid, phaseic acid, auxine, cytokinine, triacontanol; and gibberelline.

According to another embodiment of the present invention, the pasteurized sap or sap concentrate according to the present invention may comprises from about 8.3×10⁻² and up to 1 part saccharose, from 0.001×10⁻³ and up to 7.8×10⁻³ part calcium, from 0.001×10⁻³ and up to 7.8×10⁻³ part potassium, from 0.001×10⁻³ and up to 3.9×10⁻³ part magnesium, from 0.001×10⁻³ and up to 3.9×10⁻³ part sodium, from 0.001×10⁻³ and up to 1.6×10⁻³ part vannilic acid, from 0.001×10⁻³ and up to 1.6×10⁻³ part syringic acid, from 0.001×10⁻³ and up to 1.6×10⁻³ part p-Coumaric acid, from 0.001×10⁻¹ and up to 1.0×10⁻¹ of malic acid, from 0.001×10⁻³ and up to 1.6×10⁻³ part succinic acid, from 0.001×10⁻³ and up to 7.5×10⁻³ part alanine, from 0.001×10⁻² and up to 1.6×10⁻² part caline, from 0.001×10⁻² and up to 1.24×10⁻² part proline, from 0.001×10⁻² and up to 2.4×10⁻² part asparagine; and from 0.001×10⁻² and up to 4.7×10⁻² part glutamine.

According to yet another embodiment of the present invention, the pasteurized sap or sap concentrate according to the present invention may further comprises from 0 and up to 1.6×10⁻³ part of a protein matter, from 0 and up to 1.5×10⁻¹ part of fructose, from 0 and up to 1.5×10⁻¹ part of glucose, from 0 and up to 1.5×10⁻¹ part of an oligosaccharide, from 0 and up to 1.5×10⁻¹ part of a polysaccharide, from 0 and up to 1.6×10⁻³ part manganese, from 0 and up to 1.6×10⁻³ part phosphorus, from 0 and up to 7.8×10⁻⁵ part aluminum, from 0 and up to 1.6×10⁻³ part sulfur, from 0 and up to 1.6×10⁻³ part iron, from 0 and up to 1.6×10⁻³ part boron, from 0 and up to 1.6×10⁻⁴ part cadmium, from 0 and up to 1.6×10⁻⁴ part molybdenum, from 0 and up to 1.6×10⁻⁴ part selenium, from 0 and up to 1.6×10⁻⁴ part zinc, from 0 and up to 1.6×10⁻⁴ part copper, from 0 and up to 1.6×10⁻⁴ part cis-aconitate, from 0 and up to 1.6×10⁻³ part vanillin, from 0 and up to 1.6×10⁻³ part hydroxybenzoic acid, from 0 and up to 1.6×10⁻³ part syringaldehyde, from 0 and up to 1.6×10⁻³ part homovannilic acid, from 0 and up to 1.6×10⁻³ part protocatechuic acid, from 0 and up to 1.6×10⁻³ part coniferyl aldehyde, from 0 and up to 1.6×10⁻³ part coniferol, from 0 and up to 1.6×10⁻³ part lyoresinol, from 0 and up to 1.6×10⁻³ part isolariciresinol, from 0 and up to 1.6×10⁻³ part secoisolariciresinol, from 0 and up to 1.6×10⁻³ part dehydroconiferyl alcohol, from 0 and up to 1.6×10⁻³ part 5′-methoxy-dehydroconiferyl alcohol, from 0 and up to 1.6×10⁻³ part erythro-guaiacylglycerol-b-O-4′-coniferyl alcohol, from 0 and up to 1.6×10⁻³ part erythro-guaiacylglycerol-b-O-4′-dihydroconiferyl alcohol, from 0 and up to 1.6×10⁻³ part [3-[4-[(6-deoxy-α-L-mannopyranosyl)oxy]-3-methoxyphenyl]methyl]-5-(3,4-dimethoxyphenyl)dihydro-3-hydroxy-4-(hydroxymethyl)-2(3H)-furanone, from 0 and up to 1.6×10⁻³ part Scopoletin, from 0 and up to 1.6×10⁻³ part fraxetin, from 0 and up to 1.6×10⁻³ part isofraxidin, from 0 and up to 1.6×10⁻³ part gallic acid, from 0 and up to 1.6×10⁻³ part ginnalin A (acertannin), from 0 and up to 1.6×10⁻³ part ginnalin B, from 0 and up to 1.6×10⁻³ part ginnalin C, from 0 and up to 1.6×10⁻³ part methyl gallate trimethyl ether, from 0 and up to 1.6×10⁻³ part (E)-3,3′-dimethoxy-4,4′-dihydroxy stilbene, from 0 and up to 1.6×10⁻³ part ferulic acid, from 0 and up to 1.6×10⁻³ part (E)-coniferyl alcohol, from 0 and up to 1.6×10⁻³ part syringenin, from 0 and up to 1.6×10⁻³ part dihydroconiferyl alcohol, from 0 and up to 1.6×10⁻³ part C-veratroylglycol, from 0 and up to 1.6×10⁻³ part 2,3-Dihydroxy-1-(4-hydroxy-3,5-dimethoxyphenyl)-1-propanone, from 0 and up to 1.6×10⁻³ part 3-Hydroxy-1-(4-hydroxy-3,5-dimethoxyphenyl)propan-1-one, from 0 and up to 1.6×10⁻³ part 3′,4′,5′-Trihydroxyacetophenone, from 0 and up to 1.6×10⁻³ part 4-Acetylcatechol, from 0 and up to 1.6×10⁻³ part 2,4,5-Trihydroxyacetophenone, from 0 and up to 1.6×10⁻³ part 1-(2,3,4-trihydroxy-5-methylphenyl)-ethanone, from 0 and up to 1.6×10⁻³ part 2-Hydroxy-3′,4′-dihydroxyacetophenone, from 0 and up to 1.6×10⁻³ part 4-(dimethoxymethyl)-pyrocatechol, from 0 and up to 1.6×10⁻³ part catechaldehyde, from 0 and up to 1.6×10⁻³ part 3,4-Dihydroxy-2-methylbenzaldehyde, from 0 and up to 1.6×10⁻³ part Catechol, from 0 and up to 1.6×10⁻³ part catechin, from 0 and up to 1.6×10⁻³ part epicatechin, from 0 and up to 1.6×10⁻³ part fumaric acid, from 0 and up to 1.6×10⁻³ part oxalic acid, from 0 and up to 1.6×10⁻³ part pyruvic acid, from 0 and up to 1.6×10⁻³ part quinic acid, from 0 and up to 1.6×10⁻⁴ part tartaric acid, from 0 and up to 1.6×10⁻⁴ part skimic acid, from 0 and up to 1.6×10⁻³ part gluconic acid, from 0 and up to 1.6×10⁻³ part lactic acid, from 0 and up to 1.6×10⁻³ part acetic acid, from 0 and up to 1.6×10⁻³ part sarcosine, from 0 and up to 7.5×10⁻³ part glycine, from 0 and up to 1.6×10⁻³ part β-amino-isobutyric acid, from 0 and up to 1.3×10⁻³ part leucine, from 0 and up to 4.7×10⁻³ part allo-isoleucine, from 0 and up to 2.3×10⁻² part isoleucine, from 0 and up to 4.7×10⁻² part arginine, from 0 and up to 4.7×10⁻² part anserine, from 0 and up to 4.7×10⁻² part 3-methyl-histidine, from 0 and up to 4.7×10⁻² part tyrosine, from 0 and up to 4.7×10⁻² part hydroxyl proline, from 0 and up to 4.7×10⁻² part aspartic acid, from 0 and up to 4.7×10⁻² part serine, from 0 and up to 4.7×10⁻² part lysine, from 0 and up to 4.7×10⁻² part threonine, from 0 and up to 4.7×10⁻² part methionine, from 0 and up to 4.7×10⁻² part cysteic acid, from 0 and up to 1.0×10⁻³ part niacin, from 0 and up to 5.0×10⁻³ part riboflavin, from 0 and up to 1.0×10⁻³ part thiamin, from 0 and up to 1.0×10⁻³ part panthothenic acid, from 0 and up to 5.0×10⁻³ part choline, from 0 and up to 1.0×10⁻³ part vitamin B6, from 0 and up to 3.1×10⁻³ part absicissic acid, from 0 and up to 6.2×10⁻³ part phaseic acid, from 0 and up to 3.9×10⁻³ part Auxine, from 0 and up to 1.6×10⁻³ part cytokinine, from 0 and up to 1.6×10⁻³ part triacontanol; and from 0 and up to 1.6×10⁻⁴ part gibberelline.

According to another embodiment, there is provided a pasteurized or sterilized sap or sap concentrate which further comprises a preservative. According to yet another embodiment there is provided a sap or sap concentrate which comprises a preservative. Preservatives are naturally occurring or synthetically produced substance that are added to products such as foods, pharmaceuticals, paints, biological samples, wood, etc. to prevent decomposition by microbial growth or by undesirable chemical changes, such as oxidation.

According to an embodiment, the preservative may be propanoic acid, sodium propanoate, calcium propanoate, potassium propanoate, sorbic acid, sodium sorbate, potassium sorbate, and calcium sorbate, benzoic acid, sodium benzoate, potassium benzoate, and calcium benzoate, a paraben, a sulfite, ethylene oxide, propylene oxide, sodium diacetate, dehydroacetic acid, sodium nitrite, caprylic acid, ethyl formate, disodium EDTA, methylchloroisothiazolinone and an antioxidant. The paraben may be butylparaben, ethylparaben, heptylparaben, methylparaben, propylparaben, or combinations thereof. The sulfite may be caustic sulphite caramel, sulphite ammonia caramel, sodium sulphite, sodium bisulphite, sodium metabisulphite, potassium metabisulphite, potassium sulphite, calcium sulphite, calcium hydrogen sulphite, potassium hydrogen sulphite, or combinations thereof. The antioxidant may be ascorbic acid, tocopherol, propyl gallate, tertiary butylhydroquinone, butylated hydroxyanisole, butylated hydroxytoluene, or combinations thereof.

According to another embodiment, there is provided a food or food ingredient including the pasteurized or sterilized sap or sap concentrate of the present invention. As used herein, an ingredient is a substance that forms part of a food mixture (in a general sense). For example, in cooking, recipes specify which ingredients are used to prepare a specific dish. According to an embodiment, the pasteurized or sterilized sap or sap concentrate of the present invention may be used in the preparation of food, as a majority constituent of such food (e.g. when such food is a beverage, a gelatin, or other food where the bulk of the food is a fluid) or as one of the ingredient, where it may be added to the recipe.

According to another embodiment, there is provided food prepared by sterilizing and/or pasteurizing a pasteurized or sterilized sap or sap concentrate of the present invention, or crude sap or sap concentrate supplemented or not with a preservative, which is also combined with at least one food ingredient.

The at least one food ingredient may be any known and acceptable food ingredients, which include for examples, but are not limited to fruits (dehydrated or not), vegetables (dehydrated or not), fruit mixtures, vegetable mixtures, fruit purees, vegetable purees, fruit powders, vegetable powders, fruit concentrates, vegetable concentrates, juices, alcools, liquids (e.g. water, milk, etc.) spices, flavoring agents, vitamins, amino acids, oils, fats, vinegars, dairy ingredients (milks, yogurts, cheeses, etc), bacterial cultures, probiotic cultures, egg derived ingredient (yolk, egg white, egg powder, etc), dietary fibers, and combinations thereof.

The food thus prepared may then be subjected to a sterilization and/or pasteurization treatment by at least one of the methods and techniques described above, such as for example, but not limited to, a heat sterilization treatment, a dry heat sterilization treatment, a tyndallisation treatment, an upperization treatment, a high pressure processing treatment, canning, a UV treatment, a gamma ray treatment, a X-ray treatment, a pulsed light sterilization treatment, a microwave sterilization treatment, a pulsed electric field sterilization, a pulsed magnetic field sterilization, an ozone sterilization treatment, a microfiltration, a pasteurization treatment, a High Temperature Short Time (HTST) treatment, a thermization treatment, and combinations thereof. According to another embodiment, the pasteurized or sterilized sap or sap concentrate of the present invention may also be used as a culture medium. The unique formulation of the pasteurized or sterilized sap or sap concentrate of the present invention, which contains carbohydrates, amino acids, salts, as well as other molecules, make it suitable for supporting the growth of microorganisms, cells and even plants.

As used herein, a culture medium is a liquid or solid (e.g. a gel) designed to support the growth of microorganisms, cells or small plants (e.g. like the moss Physcomitrella patens), as may be appropriate for the type of microorganisms, cells or small plants.

There are two major types of growth media: those used for cell culture, which use specific cell types derived from plants or animals, and microbiological culture, which are used for growing microorganisms, such as bacteria or yeast. The most common growth media for microorganisms are nutrient broths and agar plates; specialized media are sometimes required for microorganism and cell culture growth. Some organisms, termed fastidious organisms, require specialized environments due to complex nutritional requirements. Therefore, according to some embodiment, the pasteurized or sterilized sap or sap concentrate of the present invention may be modified (e.g. pH adjustment, salinity adjustments, or the likes) and/or supplemented (e.g. addition of carbon source (e.g. carbohydrates), nucleotides or nucleotide mixtures, amino acids or amino acid mixtures, source of nitrogen, vitamins, co-factors) in order to sustain the growth.

The present invention will be more readily understood by referring to the following examples which are given to illustrate the invention rather than to limit its scope.

### Example 1

### Pasterization of Maple Sap

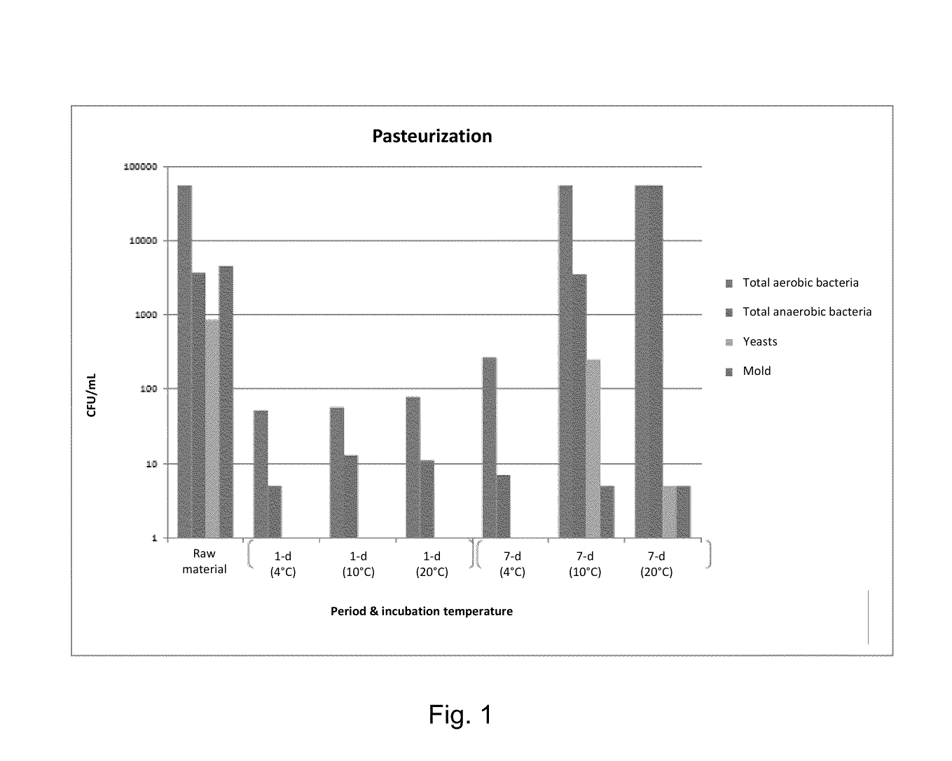

Samples of maple sap are pasteurized at 78° C. for 18 seconds in an Alfa Sterilab 4× heat exchanger P20-VB, and incubated at either 4° C., 10° C., and 20° C. for a period of 7 days. Microbiological analysis of the raw maple sap (raw material) and the samples of pasteurized maple sap is performed. FIG. 1 illustrates the total aerobic and anaerobic bacterial counts, yeasts counts, and mold counts, in Colony Forming Units per ml (CFU/ml).

TABLE 1
Bacterial counts (CFU/ml) of raw or pasteurized maple sap.

| | | Total | Total | | | Sporulated | Sporulated |
|---|---|---|---|---|---|---|---|
| | Incubation | aerobic | anaerobic | | | aerobic | anaerobic |
| | period and | bacteria | bacteria | Yeasts | Molds | bacteria | bacteria |
| Sample | temperature | (CFU/ml) | | | | | |
| Raw | N/A | 56000 | 3700 | 860 | 4600 | 8 | <1 |
| material | | | | | | | |
| (maple sap) | | | | | | | |
| Pasteurized | 1-days | 52 | 5 | 1 | 1 | 2 | <1 |
| maple sap | (4° C.) | | | | | | |
| Pasteurized | 1-days | 57 | 13 | 1 | 1 | 2 | <1 |
| maple sap | (10° C.) | | | | | | |
| Pasteurized | 1-days | 79 | 11 | 1 | 1 | 3 | <1 |
| maple sap | (20° C.) | | | | | | |
| Pasteurized | 7-days | 270 | 7 | 1 | 1 | <1 | <1 |
| maple sap | (4° C.) | | | | | | |
| Pasteurized | 7-days | 56000 | 3500 | 250 | 5 | 1 | 1 |
| maple sap | (10° C.) | | | | | | |
| Pasteurized | 7-days | 56000 | 56000 | 5 | 5 | 56000 | <1 |
| maple sap | (20° C.) | | | | | | |

The results in table 1 and FIG. 1 illustrates that pasteurization is capable of greatly reducing the bacterial contamination of maple sap, and that keeping the sap cold (4° C.) inhibits further bacterial growth prior to further storing, transporting or processing of the maple sap.

### Example 2

### Bactofugation of Maple Sap

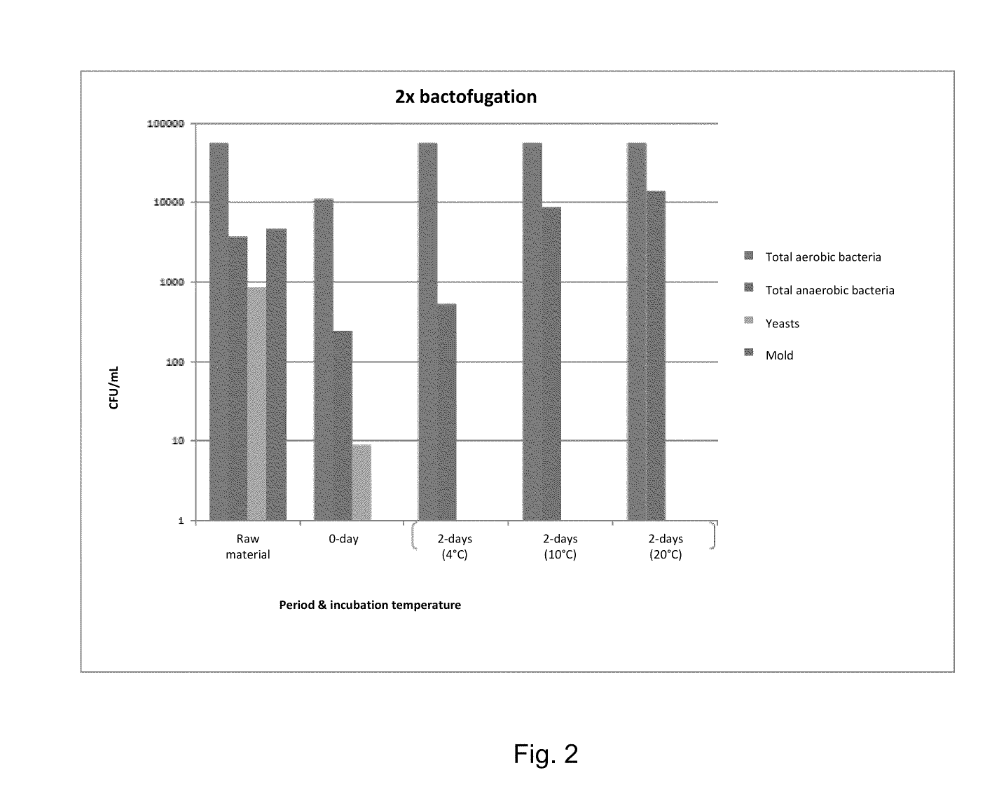

Samples of maple sap are bactofugated twice in a SE102WCV bactofuge, at an output of 60 L per hour, a bowl rotation speed of 11000 turns per minutes, and a maximum treatment capacity of 3000 L/hour, and microbiological analysis of the raw maple sap (raw material) and the sample of bactofugated maple sap is performed. FIG. 2 illustrates the total aerobic and anaerobic bacterial counts, yeasts counts, and mold counts, in Colony Forming Units per ml (CFU/ml).

TABLE 2
Bacterial counts (CFU/ml) of raw or bactofugated maple sap.

| | | Total | Total | | | Sporulated | Sporulated |
|---|---|---|---|---|---|---|---|
| | Incubation | aerobic | anaerobic | | | aerobic | anaerobic |
| | period and | bacteria | bacteria | Yeasts | Molds | bacteria | bacteria |
| Sample | temperature | (CFU/ml) | | | | | |
| Raw material | N/A | 56000 | 3700 | 860 | 4600 | 8 | <1 |
| (maple sap) | | | | | | | |
| Bactofugated | 0-day | 11000 | 240 | 9 | 1 | <1 | <1 |
| maple sap | | | | | | | |
| Bactofugated | 2-days | 56000 | 530 | 1 | 1 | <1 | <1 |
| maple sap | (4° C.) | | | | | | |
| Bactofugated | 2-days | 56000 | 8700 | 1 | 1 | <1 | <1 |
| maple sap | (10° C.) | | | | | | |
| Bactofugated | 2-days | 56000 | 14000 | 1 | 1 | 1 | <1 |
| maple sap | (20° C.) | | | | | | |

The results in table 2 and FIG. 2 illustrates that bactofugation is capable of greatly reducing the bacterial contamination of maple sap to further storing, transporting or processing of the maple sap.

### Example 3

### UV Treatment of Maple Sap

Samples of maple sap are UV treated once (1× UV) with a Hallet 30-UV Water Purification System, at an output of 30.3 L/min, and having a minimal dose of UV of 30 mJ/cm², or UV treated twice (2×UV) with a Hallet 30-UV Water Purification System, at an output of or 75.7 L/min, and having a minimal dose of UV of 30 mJ/cm². The samples are then incubated at either 4° C., 10° C., and 20° C. for a period of 7 days. Microbiological analysis of the raw maple sap (raw material) and the samples of pasteurized maple sap is performed. FIG. 1 illustrates the total aerobic and anaerobic bacterial counts, yeasts counts, and mold counts, in Colony Forming Units per ml (CFU/ml).

TABLE 3
Bacterial counts (CFU/ml) of raw or UV treated maple sap.

| | | | | | | |
|---|---|---|---|---|---|---|
| | Total | Total | | | Sporulated | Sporulated |
| Incubation | aerobic | anaerobic | | | aerobic | anaerobic |
| period and | bacteria | bacteria | Yeasts | Molds | bacteria | bacteria |

| | | |
|---|---|---|
| Sample | temperature | (CFU/ml) |

| | | | | | | | |
|---|---|---|---|---|---|---|---|
| Raw | N/A | 56000 | 2600 | 550 | 95 | 1 | 1 |
| material | | | | | | | |
| (maple sap) | | | | | | | |
| 1xUV | 1xUV 2- | 310 | 1 | 2 | 1 | 1 | 1 |
| treated | days (4° C.) | | | | | | |
| maple sap | | | | | | | |
| UV treated | 1xUV 2- | 56000 | 430 | 92 | 1 | 1 | 1 |
| maple sap | days (20° C.) | | | | | | |
| UV treated | 1xUV 7- | 5900 | 7800 | 590 | 1700 | 1 | 1 |
| maple sap | days (4° C.) | | | | | | |
| UV treated | 1xUV 7- | 56000 | 56000 | 90 | 2600 | 1 | 1 |
| maple sap | days (20° C.) | | | | | | |
| UV treated | 2xUV 2- | 16 | 3 | 5 | 1 | 1 | 1 |
| maple sap | days (4° C.) | | | | | | |
| UV treated | 2xUV 2- | 6500 | 100 | 8 | 2 | 1 | 1 |
| maple sap | days (20° C.) | | | | | | |
| UV treated | 2xUV 7- | 940 | 61 | 1400 | 2300 | 1 | 1 |
| maple sap | days (4° C.) | | | | | | |
| UV treated | 2xUV 7- | 56000 | 56000 | 5 | 1600 | 1 | 1 |
| maple sap | days (20° C.) | | | | | | |

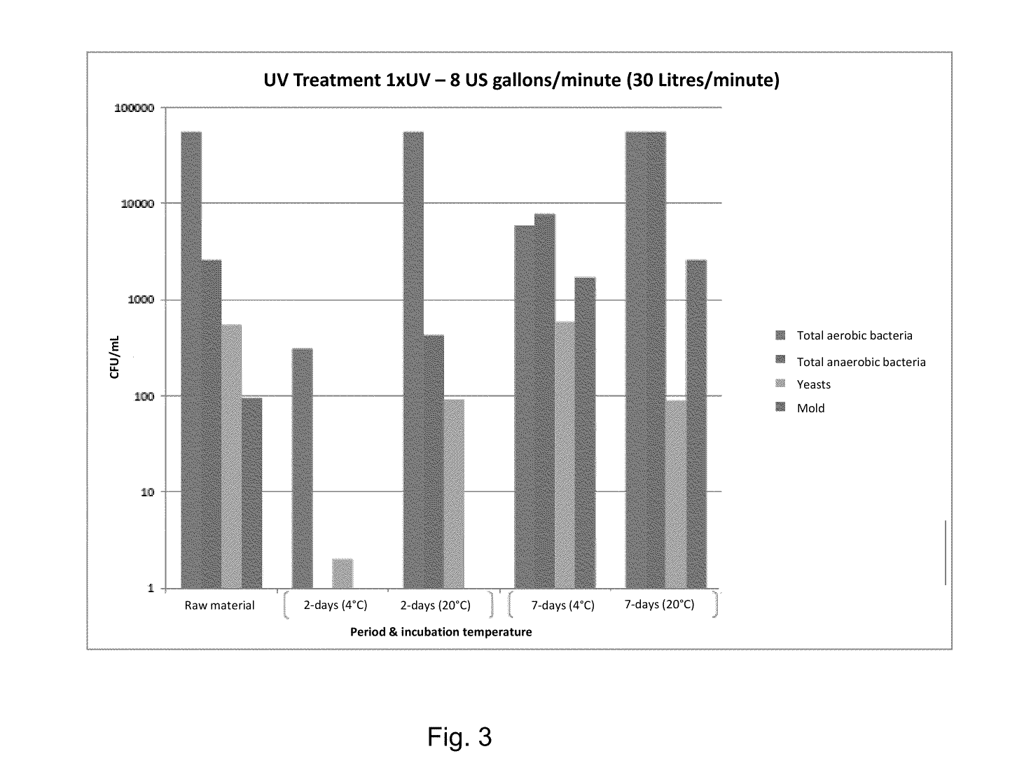

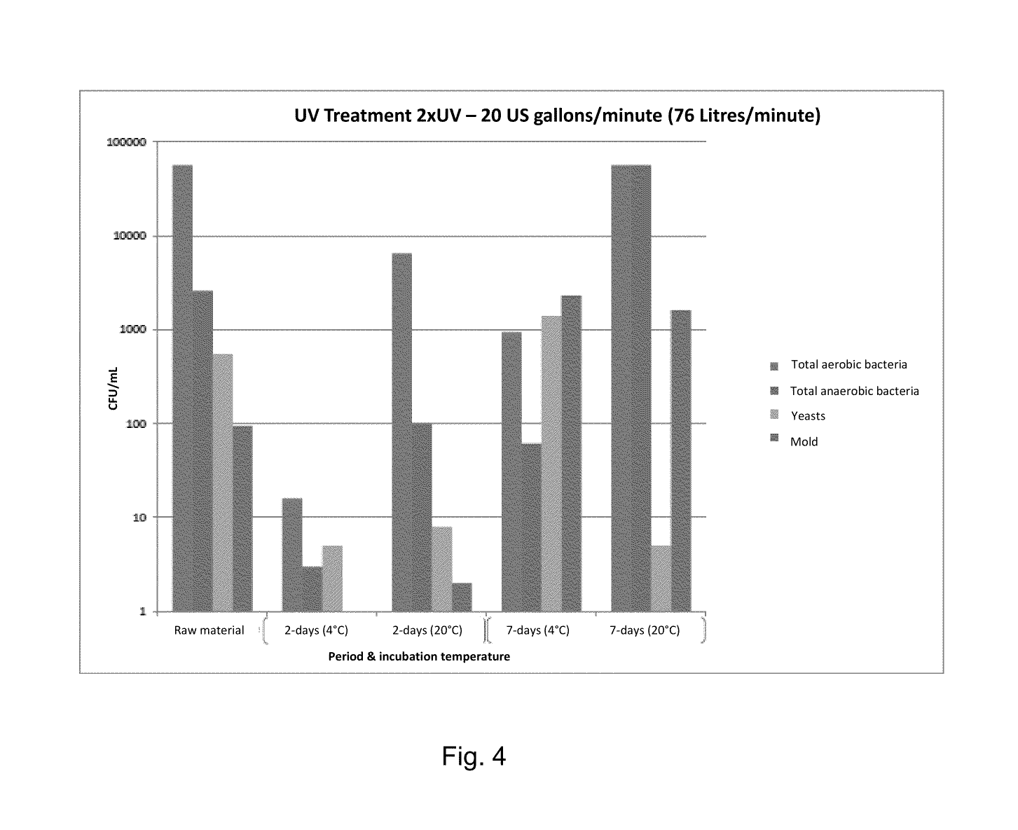

The results in table 3 and FIGS. 3 and 4 illustrates that UV treatment is capable of greatly reducing the bacterial contamination of maple sap. Keeping the sap cold (4° C.) inhibits further bacterial growth of anaerobic bacteria, but growth occurs for the aerobic and anaerobic bacteria, yeats. UV treatment would nevertheless remain a suitable treatment prior to further storing, transporting or processing of the maple sap, assuming these steps are carried out sufficiently rapidly after the initial UV treatment.

While preferred embodiments have been described above and illustrated in the accompanying drawings, it will be evident to those skilled in the art that modifications may be made without departing from this disclosure. Such modifications are considered as possible variants comprised in the scope of the disclosure.

1. In a method of sterilization and/or pasteurization of sap or sap concentrate; the improvement characterized in the step of:
a) sterilization treatment of said sap or sap concentrate for a time sufficient to substantially inhibit microbial growth in said sap or sap concentrate with minimal taste alteration, or
pasteurization treatment of said sap or sap concentrate for a time sufficient to pasteurize, wherein said pasteurization treatment is at least one of a heat pasteurization treatment, a High Temperature Short Time (HTST) treatment, a thermization treatment, a centrifugation treatment, a UV treatment, and combinations thereof, or
micro-filtration of said sap or sap concentrate with a micro-filter of pore size between about 0.1 μm to about 1 μm,
or combinations thereof,
prior to transporting, storing and transporting, transporting and storing, performing a sterilization treatment, or combinations thereof, of said sap or sap concentrate.

2. The method of claim 1, further comprising step b) after step a):
b) sterilization treatment of said sap or sap concentrate for a time sufficient to substantially inhibit microbial growth in said sap or sap concentrate with minimal taste alteration or
desiccation treatment of said sap or sap concentrate for a time sufficient to substantially eliminate water in said sap or sap concentrate.

3. The method of claim 2, further comprising the step a′) before or after step b):
a′) storing said sap or sap concentrate.

4. The method of claim 2, further comprising the step a″) before or after step b):
a″) transporting said sap or sap concentrate.

5. The method of claim 3, further comprising the step a′″) before or after steps a′):
a′″) transporting said sap or sap concentrate.

6. The method of claim 1, wherein said heat pasteurization treatment is by heating from about 50° C. to at about 100° C. for a time sufficient to pasteurize, and wherein said time sufficient to pasteurize is from about 10 seconds to about 150 minutes.

7. The method of claim 6, wherein said heat pasteurization treatment is a High Temperature Short Time (HTST) treatment from about 70° C. to 100° C. for about 15 seconds to about 30 seconds.

8. The method of claim 6, wherein said pasteurization treatment is a thermization treatment from about 63° C. to about 65° C., for about 15 to 25 seconds.

9. The method of claim 6, wherein said centrifugation treatment is a bactofugation treatment.

10. The method of claim 2, wherein said desiccation is at least one of a lyophilization, a spray drying, or combinations thereof.

11. The method of claim 3 13, wherein said storing is at least one of freezing said sap or sap concentrate, refrigerating said sap or sap concentrate, or combinations thereof.

12. The method of claim 1, wherein said sterilization treatment is at least one of a heat sterilization treatment, a dry heat sterilization treatment, a tyndallisation treatment, an upperization treatment, a high pressure processing (HPP) treatment, canning, a ultrasound treatment, a CO₂ treatment, a UV treatment, a gamma ray treatment, a X-ray treatment, a pulsed light sterilization treatment, a microwave sterilization treatment, a pulsed electric field sterilization, a pulsed magnetic field sterilization, an ozone sterilization treatment, a microfiltration, and combinations thereof.

13. The method of claim 12, wherein said heat sterilization treatment is from about 100° C. to about 160° C. for about 1 seconds to about 60 seconds, or from about 130° C. to about 150° C. for about 2 seconds to about 8 seconds, or from about 115° C. to about 137° C. for about 15 minutes to about 130 minutes, or from about 137° C. to about 140° C. for about 2 seconds to about 10 seconds.

14. The method of claim 12, wherein said high pressure processing (HPP) treatment is from about 999,74 kPa to about 999 739,808 kPa for about 4 minutes to about 30 minutes, or from about 599 843,885 kPa for about 15 minutes, or from about 599 843,885 kPa for about 6 minutes, or from about 599 843,885 kPa for about 4 minutes.

15. The method of claim 12, wherein said tyndallisation treatment is from about 70° C. to about 100° C., for about 30 mins to about 120 mins, for 3 consecutive days.

16. The method of claim 12, wherein said upperization treatment is from about 140° C. to about 150° C., for about 2 secs to about 3 seconds, followed by homogenization of said sap or sap concentrate.

17. The method of claim 12, wherein said UV treatment is from about 2000 μW s/cm² to about 9500 μW s/cm² of ultraviolet light for a time sufficient to effect sterilization, or from about 10 kGy to about 100 kGy, or from about 10 kGy or less, or from 5 kGy or less.

18. The method of claim 12, wherein said gamma ray treatment is from about 10 kGy to about 100 kGy, or from about 1 kGy to about 15 kGy, or from about 1 kGy to about 10 kGy.

19. The method of claim 12, wherein said X-ray treatment is from about 10 kGy to about 50 kGy or from about 1 kGy to about 15 kGy, or from about 1 kGy to about 10 kGy.

20. The method of claim 1, wherein said sap or sap concentrate is produced by a plant chosen from an Acer tree, a birch, a pine, a hickory, a poplar, a coconut from a coconut palm tree (Cocos nucifera), and an agave.
